(19) United States
(12) Patent Application Publication
(10) Pub. No.: US 2021/0246720 A1
(43) Pub. Date: Aug. 12, 2021

(54) SUNSHADE

(71) Applicant: Suomen Visor Oy, Kempele (FI)

(72) Inventors: Teuvo HAAPALAHTI, Oulunsalo (FI); Markku PULKKINEN, Tupos (FI); Juha PULKKINEN, Kempele (FI)

(73) Assignee: Suomen Visor Oy, Kempele (FI)

(21) Appl. No.: 17/165,664

(22) Filed: Feb. 2, 2021

(30) Foreign Application Priority Data
Feb. 6, 2020 (FI) 20205125

(51) Int. Cl. E06B 9/38; E06B 9/262

(52) U.S. Cl. CPC E06B 9/38; E06B 2009/2625; E06B 9/262

(57) ABSTRACT

The sunshade comprises a first edge strip and a second edge strip, at least two conductor wires extending from the first edge strip to the second edge strip and a movable protective curtain suspended from the conductor wires. The first edge strip and/or the second edge strip have a substantially rigid gripping projection for attachment to the edge profile of the glazing. The method comprises attaching the sunshade to a glazing element having a first edge profile and a second edge profile, wherein the edge profiles have a fastening groove in the longitudinal direction of the edge profile. The method comprises providing a substantially rigid gripping projection with a tip portion on the first edge strip, placing the first edge strip in a first position alongside the first edge profile, fitting the tip portion of the gripping projection of the first edge strip into the fastening groove of the first edge profile, and rotating the first edge strip about its longitudinal axis to a second position so that at least the tip portion of the gripping projection moves into the locking groove.

### PRIORITY

This application claims priority of Finnish national application number F120205125 which was filed on Feb. 6, 2020, and the contents of which is incorporated herein by reference.

### FIELD OF THE INVENTION

The invention relates to a sunshade comprising a first edge strip and a second edge strip, at least two conductor wires extending from the first edge strip to the second edge strip and a movable protective curtain suspended from the conductor wires. The invention further relates to a method for attaching a sunshade according to the invention to a glazing element.

### BACKGROUND

In glazed balconies, blinds are often used as sunshades to prevent excessive solar radiation from entering the balcony. Sunshades are generally fastened to the edge profile of the balcony glazing with separate fasteners, which have a gripping part for attaching to the sunshade and a suspension element for attaching to the edge profile of the balcony glazing.

Patent documents EP1957743 B1, EP 2677109 B1 and Fl 123588 B describe fasteners for sunshades comprising a gripping part for attaching to the edge rail of the sunshade and a hook-type suspension element for attaching to the edge profile of the glazing. In EP1957743 B1 and Fl 123588 B, the suspension element is fitted tightly inside a groove in the edge profile of the glazing, and in EP 2677109 B1, the suspension element is fitted tightly around one flank of the groove of the edge profile. In known fasteners the attachment to the edge profile is achieved by a tight fit of the suspension element and the edge profile. Due to the attachment based on a tight fit, the different profiles must have their own precisely dimensioned fasteners. Fasteners described in the publications cannot be moved in the longitudinal direction of the edge profile once the fastener has been installed in place. Therefore, if the installation of the fastener even slightly misses its exact intended position the first time, the fastener must be removed from the edge profile and installed again. Difficulties in using separate fasteners extend installation time and thus increase the cost of installing the sunshade.

The Finnish utility model No. 7955 discusses a glazing edge profile, which has a fastening groove for fastening the sunshade edge strip or sunshade bracket. The fastening groove is shaped to be compatible with the sunshade edge strip or sunshade bracket so that a part of the edge strip or bracket can be pushed from the end of the groove into the fastening groove, whereby the fastening groove or bracket locks into the fastening groove. The weakness of this otherwise feasible solution is that fastening is only possible if the fastening groove is open at the end and there is sufficient free installation space at the end of the groove. Thus, the fastening solution cannot be applied, for example, to window frames or doors where a uniform frame profile wraps around all edges of the glass part, or in glazings where the end of the edge profile abuts an obstacle covering the end of the fastening groove, such as a wall or an adjacent edge profile.

It is an object of the invention to provide a sunshade and a method for attaching a sunshade to a glazing element, by means of which the drawbacks associated with the prior art can be eliminated.

The objects of the invention are achieved by a sunshade and a method which are characterized by what is set out in the independent claim. Some preferred embodiments of the invention are set out in the dependent claims.

### BRIEF SUMMARY OF THE INVENTION

The invention relates to a sunshade comprising a first edge strip and a second edge strip, at least two conductor wires extending from the first edge strip to the second edge strip and a movable protective curtain suspended from the conductor wires. The first edge strip and/or the second edge strip have a substantially rigid gripping projection for attachment to the edge profile of the glazing. Preferably, the edge strip has an inner edge surface on the side of the protective curtain and an outer edge surface on the opposite side of the inner edge surface, as well as a first side surface and a second side surface.

In a preferred embodiment of the sunshade according to the invention, the gripping projection is on the outer edge surface of the edge strip. Alternatively, the gripping projection may be on the first or second side surface of the edge strip.

In another preferred embodiment of the sunshade according to the invention, the edge strip and the gripping projection are one integral piece. Preferably, the edge strip and the gripping projection are of the same metal profile. Alternatively, the edge strip and the gripping projection may be separately manufactured parts which are fixedly connected to each other in one piece.

In another preferred embodiment of the sunshade according to the invention, the gripping projection has a flank portion and a tip portion, which turns at an angle from the flank portion. Preferably, the flank portion is an extension of the second side surface of the edge strip and the tip portion turns from the flank portion toward the first side surface.

In another preferred embodiment of the sunshade according to the invention, the edge strip has a first end and a second end, and the gripping projection extends from the first end of the edge strip to the second end of the edge strip.

The invention further relates to a method for attaching a sunshade to a glazing element having a first edge profile and a second edge profile, wherein the edge profiles have a fastening groove in the longitudinal direction of the edge profile. The sunshade comprises a first edge strip and a second edge strip, at least two conductor wires extending from the first edge strip to the second edge strip and a movable protective curtain suspended from the conductor wires. The method comprises providing a substantially rigid gripping projection with a tip portion on the first edge strip, placing the first edge strip in a first position alongside the first edge profile, fitting the tip portion of the gripping projection of the first edge strip into the fastening groove of the first edge profile, and rotating the first edge strip about its longitudinal axis to a second position so that at least the tip portion of the gripping projection moves deeper into the locking groove.

A preferred embodiment of the method according to the invention comprises providing a substantially rigid gripping projection with a tip portion on the second edge strip, placing the second edge strip in a first position alongside the second edge profile, fitting the tip portion of the gripping projection of the second edge strip into the fastening groove of the second edge profile, rotating the second edge strip about its longitudinal axis to a second position so that at least the tip portion of the gripping projection moves deeper into the locking groove, and tightening the conductor wires extending from the first edge strip to the second edge strip.

In another preferred embodiment of the method according to the invention, the sunshade is attached to the edge profiles of the glazing element, which are in a substantially horizontal position. Alternatively, the sunshade can be attached to the edge profiles of the glazing element, which are in a substantially vertical position.

The advantage of the invention is that it speeds up and simplifies the attachment of the sunshades to the glazing element, because the installation work can be done completely without separate fasteners.

Another advantage of the invention is that the sunshade can be attached very close to the surface of the light-transmitting panel of the glazing element. This is especially useful in balcony glazing, where the individual glazing elements with sunshades must be able to pass each other when opening and closing the glazing.

### BRIEF DESCRIPTION OF THE DRAWINGS

The invention is described in detail below. In the description, reference is made to the accompanying drawings in which:

FIG. 1 shows by way of example a front view of a sunshade according to the invention,

FIG. 2 shows a part of the sunshade shown in FIG. 1 in cross-section, and

FIGS. 3a, 3b and 3c show by way of example a method of attaching a sunshade according to the invention by means of a series of images.

### DETAILED DESCRIPTION OF THE INVENTION

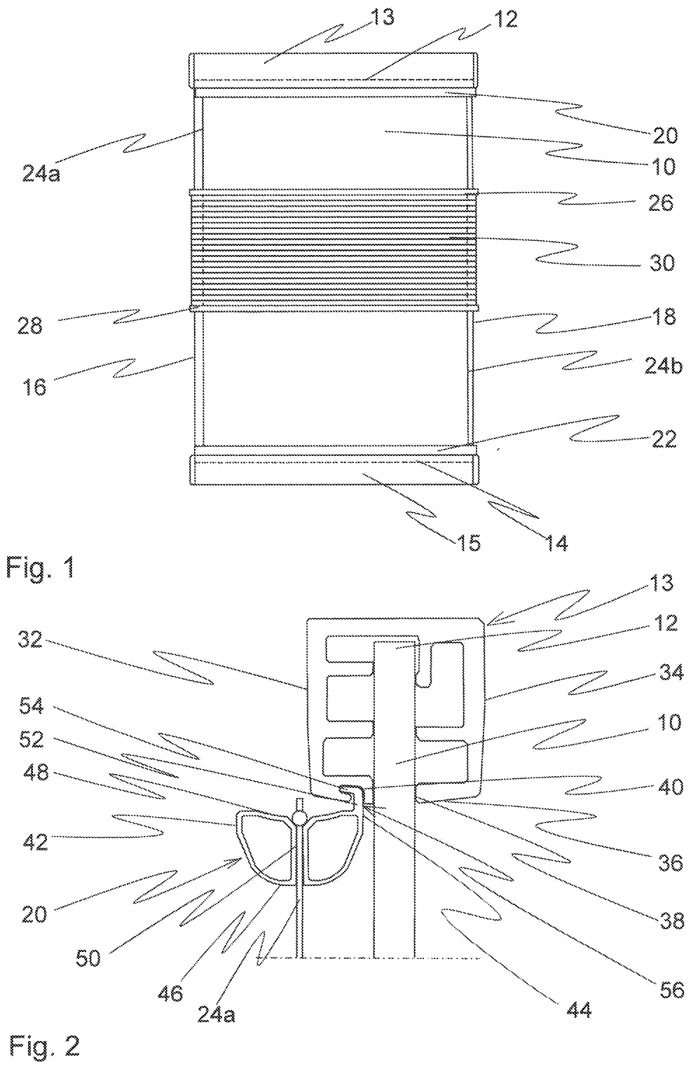

FIG. 1 shows by way of example a front view of a glazing element of a balcony glazing on which a sunshade according to the invention is installed. The glazing element comprises a rectangular light-transmitting panel 10 having two parallel side edges, i.e. a first side edge 16 and a second side edge 18, and two mutually parallel end edges, i.e. a first end edge 12 and a second end edge 14. Typically, light-transmitting panels used in balcony glazing comprise 4-6 mm thick tempered glass, but other materials and panel thicknesses are also possible. The first end edge of the light-transmitting panel has a first edge profile 13 and the second end edge has a second edge profile 15. The edge profiles are aluminum profiles with a glazing groove 38 (FIG. 2) into which the end edge of the light-transmitting panel 10 is fitted. At the ends of the edge profiles there are plastic end pieces. The side edges 16, 18 of the light-transmitting panel are free edges, i.e. edges without an edge profile.

In the method according to the invention, a sunshade according to the invention is attached to the glazing element, having a first edge strip 20 and a second edge strip 22 and two conductor wires 24a, 24b extending from the first edge strip to the second edge strip. The first edge strip is attached to the first edge profile and the second edge strip is attached to the second edge profile as described below. The first conductor wire 24a is attached at its first end close to the first end of the first edge strip 20 and at its second end close to the first end of the second edge strip. Similarly, the second conductor wire 24b is attached at its first end close to the second end of the first edge strip and at its second end close to the second end of the second edge strip. The length of the conductor wires is such that they are tense in the installed sunshade.

Suspended on the conductor wires is a curtain element which shields against solar radiation and is movable along the conductor wires, comprising an upper rail 26, a lower rail 28 and a protective curtain 30 between them. The protective curtain is attached at its upper edge to the upper rail and at its lower edge to the lower rail. The sunshade shown is a so-called pleated blind, in which the protective curtain is a curtain made of a rigid fabric that folds into a zig-zag shape. The upper and lower rails can be moved independently of each other on the conductor wires in the up/down direction so that the area covered by the protective curtain changes. The construction of the upper rail, lower rail and protective curtain is known in the art, and will not be described in more detail here.

FIG. 2 shows, in cross-section, the first edge profile 13 of the glazing element shown in FIG. 1 and the first edge strip 20 of the sunshade attached thereto. The first edge profile is a substantially hollow metal profile made of aluminum with an inner surface 32 and an outer surface 34 and an inner edge 36 extending from the inner surface to the outer surface. The inner edge has a glazing groove 38 into which the first end edge 12 of the light-transmitting panel 10 is fitted and secured in place. The glazing element is designed to be installed on the edge of the balcony so that the inner surface of the first edge profile is on the balcony side of the glazing element. At the inner edge of the first edge profile, between the glazing groove 38 and the inner surface 32, there is a fastening groove 40 along the direction of the glazing groove, which extends from the first end of the first edge profile to the second end of the edge profile. The fastening groove has a vertical portion that opens to the inner edge, and a horizontal portion turning at an angle from the bottom of the vertical portion and extending toward the inner surface 32. The vertical portion is substantially parallel to the plane of the light-transmitting panel 10 and the horizontal portion is substantially parallel to the inner edge surface.

The first edge strip 20 is a substantially hollow metal profile made of aluminum having a first side surface 42, a second side surface 44, a substantially convex inner edge surface 46 and a substantially concave outer edge surface 48. The first and second side surfaces are substantially flat surfaces. On the outer edge surface of the first edge strip, at the junction of the second side surface and the outer edge surface, there is a gripping projection 56 in the longitudinal direction of the edge strip. The gripping projection has a flank portion 52 and a tip portion 54, which turns at an angle from the plane of flank portion in the direction of the first side surface. The gripping projection is formed as an extension of the second side surface of the first edge strip so that the surface of the flank portion of the gripping part and the second side surface are substantially in the same plane. The first edge strip 20 and the gripping projection are of the same integral metal profile. In the proximity of each end of the first edge strip there is a hole 50 extending from the outer edge surface to the inner edge surface, through which a conductor wire 24a passes. At the end of the conductor wire there is a knot or a separate locking part, the diameter of which is larger than the diameter of the hole and which prevents the end of the conductor wire from leaving the hole.

The first edge strip 20 is attached to the first edge profile 13 by fitting the gripping projection 56 inside the fastening groove 40 so that the tip portion 54 of the gripping projection extends into the horizontal portion of the fastener. The first edge strip settles in the fastening position according to FIG. 2 alongside the first edge profile so that the imaginary plane defined by the edges of the outer edge surface of the edge profile is perpendicular to the plane of the light-transmitting panel. In the fastening position, the tip of the gripping projection presses against the bottom of the horizontal portion of the locking groove and the flank portion of the gripping projection presses against the wall of the vertical portion of the locking groove on the glazing groove 38 side, which prevents the first edge strip from rotating about an imaginary longitudinal axis beyond the fastening position shown in FIG. 2.

The second edge strip 22, not shown in FIG. 2, is mounted in place on the second edge profile 15 in a manner similar to the first edge strip mounted on the first edge profile. After the installation of the edge strips, the conductor wires connecting them are tightened, whereby the tension of the conductor wires prevents the edge strips from rotating about their longitudinal axis.

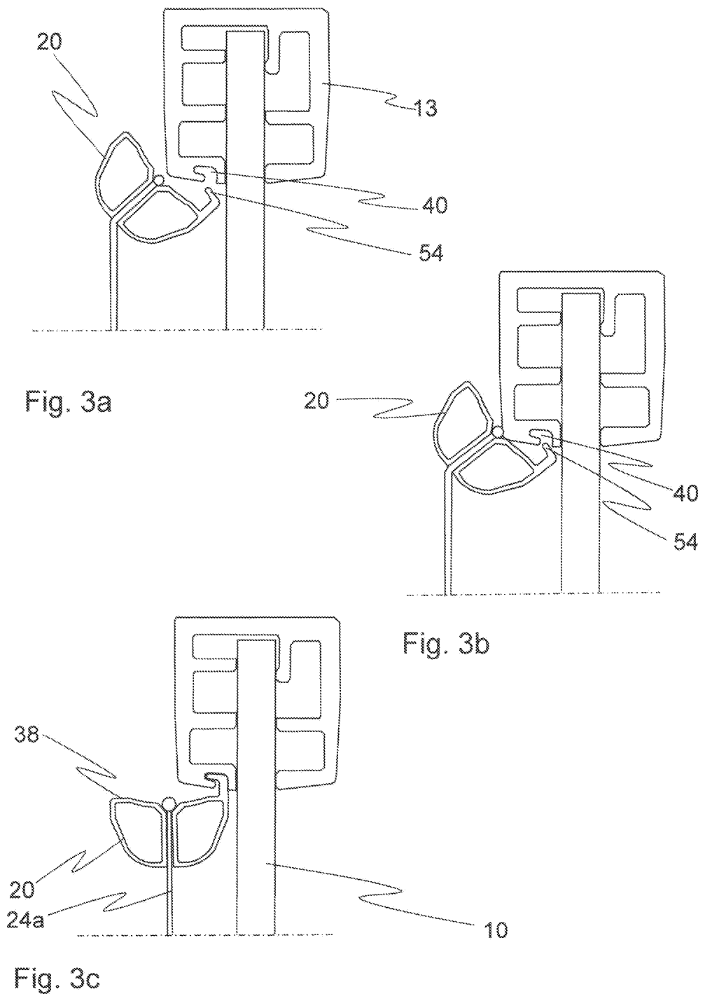

FIGS. 3a, 3b and 3c show, by means of a series of images, the attachment of a sunshade according to the invention to an edge profile by the method according to the invention. The method comprises placing the first edge strip 20 next to the first edge profile 13 in a position where the tip 54 of the gripping projection is located next to the fastening groove 40 opening into the inner edge of the edge profile (FIG. 3a). The first edge strip is then moved relative to the first edge profile so that the tip of the gripping projection rests inside the vertical part of the fastening groove (FIG. 3b). Next, the first edge strip 20 is rotated about its imaginary longitudinal axis so that the imaginary plane defined by the edges of the outer edge surface 38 of the edge strip is perpendicular to the plane of the light-transmitting panel 10 (FIG. 3c). This concludes the attachment of the first edge strip to the first edge profile. Next, the second edge strip of the sunshade is attached to the second edge profile of the same glazing element in a corresponding manner. Finally, the first conductor wire 24a and the second conductor wire, which connect the first and second edge strips, are tightened. This concludes the installation of the sunshade to the glazing element. The tense conductor wires and the pulling force applied by them to the edge strips prevent the edge strips from rotating about their longitudinal axis, so that the edge strips cannot become detached from the fastening groove.

The best way to attach the sunshade to the glazing element according to FIG. 1 is to first attach the first edge profile to the first edge profile at the top of the glazing element, whereby the gravitational pull acting on the first edge strip automatically turns the edge strip into the fastening position according to FIG. 2 and keeps the edge strip in this position. The second edge strip is then easy to attach to the second edge profile at the lower edge of the glazing element. Of course, it is also possible to first attach the first edge strip to the lower edge profile of the glazing element and then attach the second edge strip to the upper edge profile of the glazing element.

The glazing element shown by way of example in FIG. 1 is a part of a balcony glazing with edge profiles only at the top and bottom edges of the light-transmitting panel. The glazing element may also have edge profiles with locking grooves on both vertical edges of the light-transmitting panel. In this case, the sunshade according to the invention can be attached to the glazing element by the method described above so that the first edge strip is attached to the edge profile on a first vertical edge of the light-transmitting panel and the second edge strip is attached to the second edge profile on a second vertical edge of the light-transmitting panel. The glazing element does not have to be part of balcony glazing, but can be, for example, a window or a door with a glass panel.

The conductor wires can be attached to the edge strips and tightened to a suitable tension when installing the edge strips. Alternatively, elastic cords can be used as conductor wires, pre-dimensioned to a suitable length and fastened at their ends to the edge strips. The elasticity of the conductor wires makes it possible to fit the gripping projection of the subsequently fastened second edge strip in the fastening groove of the second edge profile when the first edge strip has already been fastened in place to the first edge profile.

Some preferred embodiments of the sunshade and the method for attaching the sunshade according to the invention have been described above. The invention is not limited to the solutions described above, but the invention can be implemented in various ways within the scope defined by the claims.

### LIST OF REFERENCE NUMBERS

10 panel

12 first end edge

13 first edge profile

14 second end edge

15 second edge profile

16 first side edge

18 second side edge

20 first edge strip

22 second edge strip

24a first conductor wire

24b second conductor wire

26 upper rail

28 lower rail

30 protective curtain

32 inner surface

34 outer surface

36 inner edge

38 glazing groove

40 fastening groove

42 first side surface

44 second side surface

46 inner edge surface

48 outer edge surface

50 hole

52 flank portion

54 tip portion

56 gripping projection

1. A sunshade comprising a first edge strip (20) and a second edge strip (22), at least two conductor wires (24a, 24b) extending from the first edge strip (20) to the second edge strip (22) and a movable protective curtain (30) suspended from the conductor wires (24a, 24b), wherein the first edge strip (20) and/or the second edge strip (22) have a substantially rigid gripping projection (56) for attachment to a glazing edge profile (13, 15).

2. The sunshade of claim 1, wherein the edge strip (20, 22) has an inner edge surface (46) on the side of the protective curtain (30) and an outer edge surface (48) on the opposite side of the inner edge surface (46), as well as a first side surface (42) and a second side surface (44).

3. The sunshade of claim 2, wherein the gripping projection (56) is on the outer edge surface (48) of the edge strip.

4. The sunshade of claim 2, wherein the gripping projection (56) is on the first or second side surface (42, 44) of the edge strip.

5. The sunshade of claim 1, wherein the edge strip (20, 22) and gripping projection (56) are one integral piece.

6. The sunshade of claim 1, wherein the gripping projection (56) has a flank portion (52) and a tip portion (54), which turns at an angle from the flank portion (52).

7. The sunshade of claim 6, wherein the flank portion (52) is an extension of the second side surface (44) of the edge strip (20, 22) and the tip portion (54) turns from the flank portion (52) toward the first side surface (42).

8. The sunshade of claim 1, wherein the edge strip (20, 22) has a first end and a second end, and the gripping projection (56) extends from the first end of the edge strip (20, 22) to the second end of the edge strip.

9. A method for attaching a sunshade to a glazing element having a first edge profile (13) and a second edge profile (15), the edge profiles having a fastening groove (40) in the longitudinal direction of the edge profile, the sunshade comprising a first edge strip (20) and a second edge strip (22), at least two conductor wires (24a, 24b) extending from the first edge strip (20) to the second edge strip (22) and a movable protective curtain (30) suspended from the conductor wires (24a, 24b), comprising:
providing a substantially rigid gripping projection (56) with a tip portion (54) on the first edge strip (20);
placing the first edge strip (20) in a first position alongside the first edge profile (13);
fitting the tip portion (54) of the gripping projection (56) of the first edge strip (20) into the fastening groove (40) of the first edge profile (13); and
rotating the first edge strip (20) about its longitudinal axis to a second position so that at least the tip portion (54) of the gripping projection (56) moves deeper into the fastening groove (40).

10. The method of claim 9, wherein the method further comprises:
providing a substantially rigid gripping projection (56) with a tip portion (54) on the second edge strip (22);
placing the second edge strip (22) in a first position alongside the second edge profile (15);
fitting the tip portion (54) of the gripping projection (56) of the second edge strip (22) into the fastening groove (40) of the second edge profile (15);
rotating the second edge strip (22) about its longitudinal axis to a second position so that at least the tip portion (54) of the gripping projection (56) moves deeper into the fastening groove (40), and
tightening the conductor wires (24a, 24b) extending from the first edge strip (20) to the second edge strip (22).

11. The method of claim 9, wherein the sunshade is attached to the edge profiles (13, 15) of the glazing element, which are in a substantially horizontal position.

12. The method of claim 9, wherein the sunshade is attached to the edge profiles (13, 15) of the glazing element, which are in a substantially vertical position.
